(19) United States
(12) Patent Application Publication
(10) Pub. No.: US 2025/0233401 A1
(43) Pub. Date: Jul. 17, 2025

(54) METHOD AND DEVICE FOR MONITORING AN ELECTRICAL-ENERGY SUPPLY NETWORK OF AN AIRCRAFT

(71) Applicant: SAFRAN ELECTRICAL & POWER, Blagnac (FR)

(72) Inventors: Eric GUILLARD, Moissy-Cramayel (FR); Vincent CHAPERON, Moissy-Cramayel (FR)

(73) Assignee: SAFRAN ELECTRICAL & POWER, Blagnac (FR)

(21) Appl. No.: 19/011,058

(22) Filed: Jan. 6, 2025

(30) Foreign Application Priority Data
Jan. 16, 2024 (FR) 2400425

(51) Int. Cl. H02H 3/00

(52) U.S. Cl. CPC H02H 3/006

(57) ABSTRACT

A method and a system for monitoring an electrical-energy supply network of an aircraft, wherein the electrical-energy supply network includes a plurality of protection and distribution devices connected together by at least one communication bus. According to the invention, each protection and distribution device: determines its location in the network, selects a configuration table associated with its location, receives a state table from each other protection and cutoff device, applies at least a part of the state tables to a job-related rule determining whether a contactor of the protection and cutoff device must be open or closed, controls the contactor according to the result of the job-related rule, and transfers an updated state table to each other protection and cutoff device.

### TECHNICAL FIELD

The present invention relates to a method, a system and a device for monitoring an electrical-energy supply network of an aircraft.

### PRIOR ART

In the aeronautical field, the supply of electrical energy to the various items of equipment of an aircraft is provided by at least one electrical-energy supply source, preferentially by several electrical-energy supply sources so as to mitigate any operating fault in one or more electrical-energy supply sources. According to the functioning or malfunctioning of a supply source, of a contactor or of a load, a centralised monitoring system demands the opening or closing of remote contactors to reconfigure the electrical-energy supply network so as to isolate the operating fault and to guarantee the correct operation of the other elements connected to the electrical-energy supply network.

For safety reasons, the centralised monitoring system is very often duplicated.

The wiring and the configuration of the various elements of the electrical-energy supply network fix the software loaded in the centralised monitoring system. It is thus difficult to change the electrical-energy supply network over time. For each type or version of aircraft, it is necessary to develop a centralised monitoring system dedicated to configuring the various elements of the electrical-energy supply network.

In addition, maintaining electrical-energy supply networks controlled in a centralised manner is also complex.

It is in particular desirable to provide a solution that makes it possible to manage an electrical-energy supply network of an aircraft more flexibly over time while reducing the wiring of the various elements of the electrical-energy supply network.

### DISCLOSURE OF THE INVENTION

A method is proposed for managing monitoring of an electrical-energy supply network of an aircraft, the electrical-energy supply network comprising a plurality of protection and distribution devices connected together by at least one communication bus, characterised in that the method comprises the steps, performed by each protection and distribution device, of:
determining the location of the protection and distribution device in the electrical-energy supply network of an aircraft,
selecting, from a set of configuration tables stored in the protection and distribution device, a configuration table associated with the location of the protection and distribution device in the electrical-energy supply network of an aircraft,
receiving a state table from each other protection and cutoff device,
applying at least a part of the state tables to a job-related rule determining whether a contact of the protection and cutoff device must be open or closed,
controlling the contactor according to the result of the job-related rule,
transferring an updated state table to each other protection and cutoff device.

The invention also relates to a protection and distribution device included in an electrical-energy supply network of an aircraft comprising a plurality of protection and distribution devices connected together by at least one communication bus, characterised in that the protection and distribution device comprises:
means for determining the location of the protection and distribution device in the electrical-energy supply network of an aircraft,
means for selecting, from a set of configuration tables stored in the protection and distribution device, a configuration table associated with the location of the protection and distribution device in the electrical-energy supply network of an aircraft,
means for receiving a state table from each other protection and cutoff device,
means for applying at least a part of the state tables to a job-related rule determining whether the contactor of the protection and cutoff device must be open or closed,
means for controlling the contactor according to the result of the job-related rule,
means for transferring an updated state table to each other protection and cutoff device.

The invention also relates to a protection and distribution system included in an electrical-energy supply network of an aircraft comprising a plurality of protection and distribution devices, characterised in that the protection and distribution devices are connected together by at least one communication bus, each protection and distribution device comprises:
means for determining the location of the protection and distribution device in the electrical-energy supply network of an aircraft,
means for selecting, from a set of configuration tables stored in the protection and distribution device, a configuration table associated with the location of the protection and distribution device in the electrical-energy supply network of an aircraft,
means for receiving a state table from each other protection and cutoff device,
means for applying at least a part of the state tables to a job-related rule determining whether the contactor of the protection and cutoff device must be open or closed,
means for controlling the contactor according to the result of the job-related rule,
means for transferring an updated state table to each other protection and cutoff device.

Thus the present invention makes it possible to manage an electrical-energy supply network of an aircraft more flexibly over time while reducing the wiring of the various elements of the electrical-energy supply network.

In addition, the present invention, by using the same type of protection and distribution device whatever the location thereof in the electrical-energy supply network, the wiring of the electrical-energy supply network is simplified and simple to implement.

The monitoring of the electrical-energy supply network, by virtue of its decentralised structure, reduces the complexity of the electrical-energy supply network. The complexity is reduced through a simplification of the wiring by virtue of the use of the communication bus.

According to a particular embodiment, the method furthermore comprises a step of testing the integrity of the protection and distribution device, and the determination, selection, reception, application, control and transfer steps are performed if the integrity test is positive.

According to a particular embodiment, the job-related rule determining whether the contactor of the protection and cutoff device must be open or closed furthermore takes into account at least one current and/or voltage measured by the protection and cutoff device and maximum and/or minimum current and/or voltage values included in the configuration table selected.

According to a particular embodiment, the method furthermore comprises the steps of:
checking where an updating of the configuration tables must be performed,
updating the configuration tables prior to the selection.

Thus the present invention makes it possible to adapt simply to any modifications of the electrical-energy supply network of the aircraft.

According to a particular embodiment, the network comprises a plurality of voltage sources, a plurality of loads consuming electrical energy and a plurality of supply buses, and a protection and cutoff device is disposed between each voltage source and a supply bus, a protection and cutoff device is disposed between each load and a supply bus and at least one protection and cutoff device is disposed between two supply buses.

A program that can be stored on a medium and/or downloaded from a communication network, in order to be read by a processor, is also proposed. This program comprises instructions for implementing the method implemented by each protection and distribution device, as mentioned above, when said program is executed by the processor. The invention also relates to an information storage medium storing such a program.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates an example of an architecture of an electrical-energy supply network of an aircraft wherein the electrical-energy supply network of an aircraft is monitored in a distributed manner by a plurality of protection and distribution devices;

FIG. 2 illustrates an example of architecture of a protection and distribution device according to the present invention;

FIG. 3 illustrates an example of an algorithm executed by each protection and distribution device according to the present invention;

FIG. 4 illustrates a particular example of a simplified architecture of an electrical-energy supply network of an aircraft according to the present invention.

### DETAILED DISCLOSURE OF EMBODIMENTS

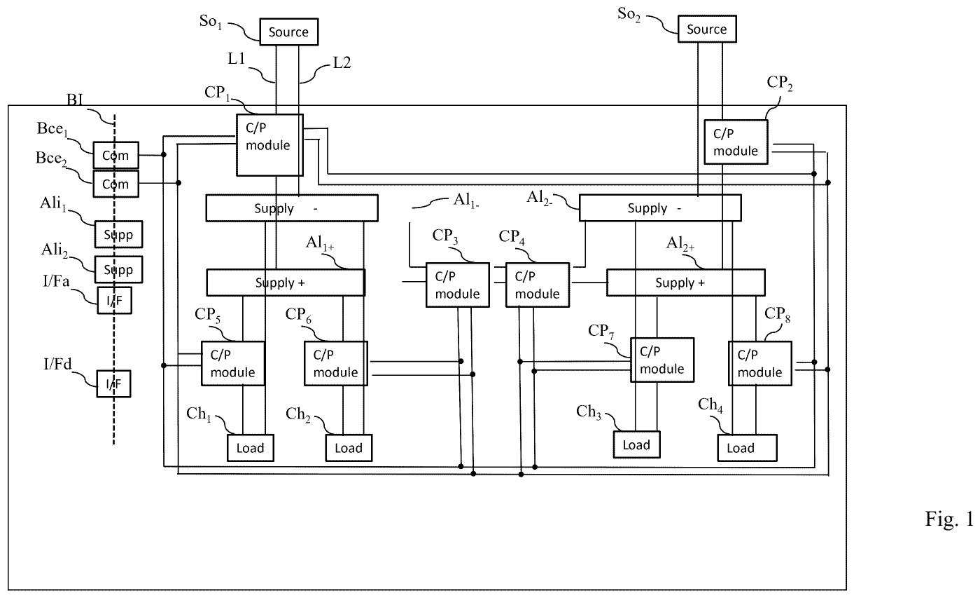

FIG. 1] illustrates an example of an architecture of an electrical-energy supply network of an aircraft wherein the electrical-energy supply network of an aircraft is monitored in a distributed manner by a plurality of protection and distribution devices.

In the example in FIG. 1, the electrical-energy supply network of the aircraft comprises two voltage sources So₁ and So₂, four loads Ch₁ to Ch₄ and a plurality of protection and distribution devices CP₁ to CP₈ also called C/P modules.

The protection and distribution devices CP₁ to CP₈ are connected together by two communication buses Bce₁ and Bce₂. The communication buses Bce₁ and Bce₂ are identical and are two in number for reasons of reliability should one of them be faulty.

The communication buses Bce₁ and Bce₂ allow data exchanges between the protection and distribution devices CP₁ to CP₈ and are connected respectively by an interface to a communication system of the aircraft, not shown in FIG. 1.

The protection and distribution devices CP₁ to CP₈ are supplied by two power supplies Ali₁ and Ali₂.

The power supplies Ali₁ and Ali₂ are connected to external power supplies of the aircraft, not shown in FIG. 1.

In a particular embodiment, an analogue interface I/Fa is connected to the communication buses Bce₁ and Bce₂. The analogue interface I/Fa allows the exchange of data with sensors or actuators of the aircraft.

In a particular embodiment, a discrete interface I/Fd is connected to the communication buses Bce₁ and Bce₂. The discrete interface I/Fd allows the exchange of data with control or notification elements of the aircraft.

An isolation barrier BI provides galvanic isolation between the electrical-energy supply network and other electrical elements of the aircraft.

The protection and distribution device CP₁ is connected to the voltage source So₁ and, according to the state of the contactor that it comprises internally, connects or not a positive termination of the voltage source So₁ to a positive supply bus Al₁₊.

The connection between the positive termination of the voltage source So₁ and the positive supply bus Al₁₊ is denoted L1 and the connection between the negative termination of the voltage source So₁ and the negative supply bus Al₁₋ is denoted L2.

A negative termination of the voltage source So₁ is connected to a negative supply bus Al₁₋.

The protection and distribution device CP₂ is connected to the voltage source So₂ and, according to the state of the contactor that it comprises internally, connects or not a positive termination of the voltage source So₂ to a positive supply bus Al₂₊.

A negative termination of the voltage source So₂ is connected to a negative supply bus Al₂₋.

The protection and distribution devices CP₃ and CP₄ make it possible, according to the state of the contactor that they comprise internally, to connect or not the positive supply buses Al₁₊ and Al₂₊.

The protection and distribution device CP₅ is connected to the load Ch₁ and, according to the state of the contactor that it comprises internally, connects or not a positive termination of the load Ch₁ to the positive supply bus Al₁₊.

The protection and distribution device CP₆ is connected to the load Ch₂ and, according to the state of the contactor that it comprises internally, connects or not a positive termination of the load Ch₂ to the positive supply bus Al₁₊.

The protection and distribution device CP₇ is connected to the load Ch₃ and, according to the state of the contactor that it comprises internally, connects or not a positive termination of the load Ch₃ to the positive supply bus Al₂₊.

The protection and distribution device CP₈ is connected to the load Ch₄ and, according to the state of the contactor that it comprises internally, connects or not a positive termination of the load Ch₄ to the positive supply bus Al₂₊.

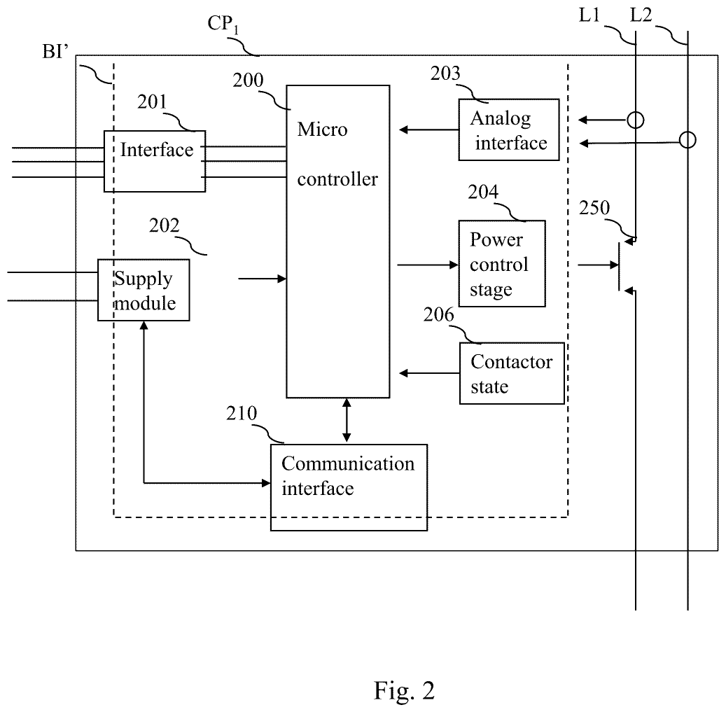

FIG. 2 illustrates an example of the protection and distribution device CP₁.

It should be noted here that the protection and distribution devices CP₁ to CP₈ have identical architectures.

The protection and distribution device CP₁ comprises a microcontroller 200, a programming interface 201, a supply module 202, an analogue interface 203, a power control stage 204, a contactor 250, a communication interface 210 and an interface 206 for obtaining the state of the contactor 250.

The interface 206 for obtaining the state of the contactor 250 comprises an auxiliary contactor, not shown in FIG. 2, which is controlled by the coil that controls the contactor 250. When the contactor 250 is closed, the auxiliary contactor is also closed. When the contactor 250 is open, the auxiliary contactor is also open. For example, when the auxiliary contactor is closed, a logic high level is present on an input of the interface for obtaining the state of the contactor 250. When the auxiliary contactor is open, a logic low level is present on the input of the interface for obtaining the state of the contactor 250.

The microcontroller 200 comprises, not shown in FIG. 2, a random access memory RAM; a read only memory ROM or a flash memory; and at least one set of inputs/outputs.

The microcontroller 200 is capable of executing instructions loaded in the RAM from the ROM, or from a communication bus Bce₁ or Bce₁. When the microcontroller 200 is powered up, the microcontroller 200 is capable of reading instructions in the RAM and executing them. These instructions form a computer program causing the implementation, by the microcontroller 200, of all or some of the behaviours of the algorithm and steps described here.

Thus all or some of the algorithms and steps described here can be implemented in software form by executing a set of instructions by a programmable machine, such as a DSP (“digital signal processor”) or the microcontroller 200. All or some of the algorithms and steps described here can also be implemented in hardware form by a machine or a component (chip), such as an FPGA (“field-programmable gate array”), or an ASIC (“application-specific integrated circuit”). Thus the microcontroller 200 comprises electronic circuitry adapted and configured to implement the behaviours, the algorithm and steps described here.

The ROM memory comprises a plurality of equations for closing and opening the contactor 250.

Each job-related rule, also referred to as operating rule, for closing or opening the contactor 250 corresponds to an allocation of the protection and distribution device in the electrical-energy supply network of the aircraft. Each job-related rule for closing or opening the contactor takes into account the state of at least some of the contactors included in the other protection and distribution devices of the electrical-energy supply network of the aircraft. Each closure job-related rule is included respectively in a configuration table.

The programming interface 201 makes it possible to indicate, by means of programming pins, the allocation, or in other words the position, of the protection and distribution device.

The supply module 202 makes it possible, from the power supplies Ali₁ or Ali₂, to supply the protection and distribution device.

By means of the analogue interface 203, the microcontroller 200 receives voltage and/or current measurements measured by the connections L1 and L2.

The power control stage 204 makes it possible to control the opening or closing of the contactor 250.

The interface 206 for obtaining the state of the contactor 250 enables the microcontroller 200 to know in what state the contactor 250 is.

By means of the communication interface 210, the microcontroller 200 transfers, over the communication bus Bce₁ or Bce₂, state tables of the contactor 250 to each protection and distribution device and to receive, from each protection and distribution device and via the communication bus Bce₁ or Bce₂, state tables of their respective contactor.

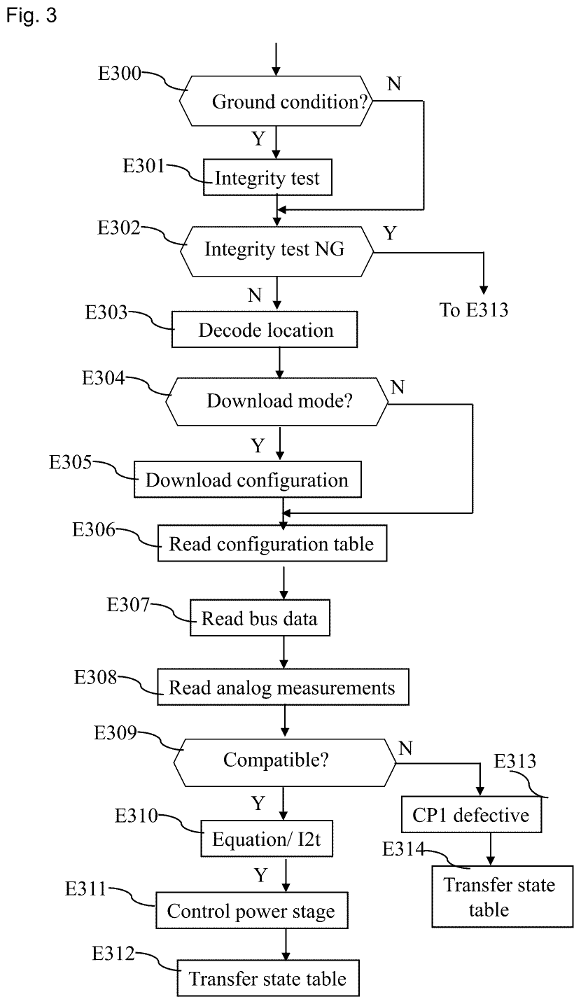

FIG. 3 illustrates an example of an algorithm executed by each protection and distribution device according to the present invention.

The present algorithm is for example executed with a periodicity of the order of one millisecond.

The present algorithm is described in an example in which it is executed by the protection and distribution device CP₁.

At the step E300, the microcontroller 200 checks whether the aircraft is on the ground. The microcontroller 200 is informed of the presence on the ground of the aircraft by means of the communication bus Bce₁ or Bce₂ or by means of the discrete interface IFd.

If so, the microcontroller 200 passes to the step E301. If not, the microcontroller 200 passes to the step E302.

At the step E301, the microcontroller proceeds with a test on the integrity of the operation of the protection and distribution device.

The integrity test consists for example of a check on the coherence of the inputs and outputs of the analogue acquisition chain included in the analogue interface 203, on the correct operation of the communication interface 210 and of the communication buses and on good access to the memory.

At the step E302, the microcontroller 200 checks whether the integrity test is negative. If the integrity test is negative, the microcontroller 200 passes to the step E312.

If the integrity test is positive, the microcontroller 200 passes to the step E303.

At the step E303, the microcontroller 200 obtains from the interface 201 a binary word indicating the allocation of the protection and distribution device. The binary word is defined by microswitches or jumpers or given wiring.

At the step E304, the microcontroller 200 checks whether software must be downloaded. For example, a software downloading is notified to the protection and distribution device by means of the communication bus Bce₁ or Bce₂.

In the affirmative, the microcontroller 200 passes to the step E305. In the negative, the microcontroller 200 passes to the step E306.

At the step E305, the microcontroller 200 proceeds with the downloading of the software via the communication bus Bce₁ or Bce₂.

At the step E306, the microcontroller 200 reads the configuration table associated with the binary word indicating the allocation of the protection and distribution device.

The configuration table comprises for example information indicating whether a voltage measurement and/or one or more current measurements must be made, a tripping current, a maximum difference between the current circulating in the lines L1 and L2, a minimum value of the voltage measured between the lines L1 and L2, a maximum value of the voltage measured between the lines L1 and L2, a job-related rule determining whether the contactor 250 must be open or closed.

At the following step E307, the microcontroller 200 obtains, from the communication interface 210, data received by means of the interface I/Fd on control or notification elements of the aircraft as well as, for each other protection and distribution device CP₂ to CP₈, a state table of the contactor of the protection and distribution device CP₂ to CP₈.

At the following step E308, the microcontroller 200 obtains, from the analogue interface, depending on the content of the configuration table, at least one current and/or voltage measurement.

At the following step E309, the microcontroller 200 checks whether the measurements obtained at the step E308 are compatible with the minimum and maximum values included in the configuration table.

If the measurements obtained are compatible with the minimum and maximum values included in the configuration table, the microcontroller 200 passes to the step E310.

If not, the microcontroller 200 passes to the step E313.

At the step E310, the microcontroller 200 uses the measured current, the tripping current and the state tables of at least some of the protection and distribution devices CP₂ the CP₈ and applies these to the job-related rule determining whether the contactor 250 must be open or closed.

At the step E311, the microcontroller 200 controls the power control stage 204 to apply, to the contactor 250, the state obtained of the job-related rule determining whether the contactor 250 must be open or closed.

At the step E312, the microcontroller 200 demands the transfer, by means of the communication interface 210, of the state table updated with the state obtained of the job-related rule determining whether the contactor 250 must be open or closed.

At the step E313, the microcontroller 200 considers that the protection and distribution device CP₁ is defective and updates the state table.

If the communication interface 210 is operational, at the step E314, the microcontroller 200 demands the transfer, by means of the communication interface 210, of the state table updated with the state obtained of the job-related rule determining whether the contactor 250 must be open or closed.

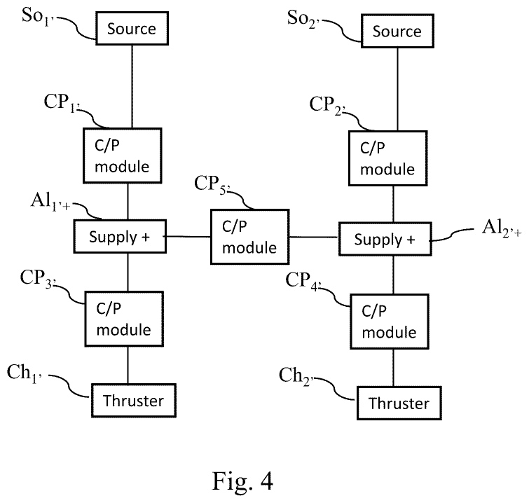

FIG. 4 illustrates a particular example of a simplified architecture of an electrical-energy supply network of an aircraft according to the present invention.

In the example in FIG. 4, only two voltage sources So_{1′} and So_{2′}, two loads Ch_{1′} and Ch_{2′}, two positive supply buses Al_{1′+} and Al_{12′+} and five protection and distribution devices CP_{1′}to CP_{5′} are shown.

The protection and distribution device CP_{1′} is disposed between the voltage source So_{1′} and the positive supply bus Al_{1′+}.

The protection and distribution device CP_{2′} is disposed between the voltage source So_{2′} and the positive supply bus Al_{2′+}.

The protection and distribution device CP_{3′} is disposed between the positive supply bus Al_{1′+} and the load Ch_{1′}.

The protection and distribution device CP_{4′} is disposed between the positive supply bus Al_{2′+} and the load Ch_{2′}.

The protection and distribution device CP_{5′} is disposed between the positive supply bus Al_{1′+} and the positive supply bus Al_{2′+}.

In conventional operation, the contactor of the protection and distribution device CP_{1′} is closed, the contactor of the distribution and protection device CP_{2′} is closed, the contactor of the protection and distribution device CP_{3′} is closed, the contactor of the protection and distribution device CP_{4′} is closed and the contactor of the protection distribution device CP_{5′} is open.

The result of the job-related rule for closing the contactor of the distribution and protection device CP_{5′} is closure of the contactor if the contactor of the distribution and protection device CP_{1′} is open, the contactor of the protection and distribution device CP_{2′} is closed, the contactor of the protection and distribution device CP_{3′} is closed and the contactor of the protection distribution device CP_{4′} is closed.

If the protection and distribution device CP_{1′} detects a voltage delivered by the voltage source So_{1′} below a maximum value, it demands opening of its contactor and transfer as an updated state table.

When the distribution and protection device CP_{5′} receives the updated state table of each protection and distribution device CP_{1′} CP_{4′}, the protection and distribution device CP_{5′} applies it to the job-related rule determining whether the contactor 250 must be open or closed, controls the power stage to close the contactor and transfers an updated state table.

The present invention is described in an environment in which the voltage sources are DC. The present invention is also applicable when the voltage sources supply an alternating voltage.

1. A method for monitoring an electrical-energy supply network of an aircraft, wherein the electrical-energy supply network comprises a plurality of protection and distribution devices connected together by at least one communication bus, wherein the method comprises the steps, performed by each protection and distribution device, of:
determining the location of the protection and distribution device in the electrical-energy supply network of an aircraft,
selecting, from a set of configuration tables stored in the protection and distribution device, a configuration table associated with the location of the protection and distribution device in the electrical-energy supply network of an aircraft,
receiving a state table from each other protection and cutoff device,
applying at least a part of the state tables to a job-related rule determining whether a contactor of the protection and cutoff device must be open or closed,
controlling the contactor according to the job-related rule,
transferring an updated state table to each other protection and cutoff device.

2. The method according to claim 1, wherein the job-related rule determining whether the contactor of the protection and cutoff device must be open or closed furthermore takes into account at least one current and/or voltage measured by the protection and cutoff device and maximum and/or minimum current and/or voltage values included in the configuration table selected.

3. The method according to claim 1, wherein the method furthermore comprises the steps of:
checking where an updating of the configuration tables must be performed,
updating the configuration tables prior to the selection.

4. The method according to claim 1, wherein the method furthermore comprises a step of testing the integrity of the protection and distribution device and in that the determination, selection, reception, application, control and transfer steps are performed if the integrity test is positive.

5. A protection and distribution device included in an electrical-energy supply network of an aircraft comprising a plurality of protection and distribution devices connected together by at least one communication bus, wherein the protection and distribution device comprises electronic circuitry configured for:
determining the location of the protection and distribution device in the electrical-energy supply network of an aircraft,
selecting, from a set of configuration tables stored in the protection and distribution device, a configuration table associated with the location of the protection and distribution device in the electrical-energy supply network of an aircraft,
receiving a state table from each other protection and cutoff device,
applying at least a part of the state tables to a job-related rule determining whether the contactor of the protection and cutoff device must be open or closed,
controlling the contactor according to the result of the job-related rule,
transferring an updated state table to each other protection and cutoff device.

6. A protection and distribution system included in an electrical-energy supply network of an aircraft comprising a plurality of protection and distribution devices, wherein the protection and distribution devices are connected together by at least one communication bus, each protection and distribution device comprises electronic circuitry configured for:
determining the location of the protection and distribution device in the electrical-energy supply network of an aircraft,
selecting, from a set of configuration tables stored in the protection and distribution device, a configuration table associated with the location of the protection and distribution device in the electrical-energy supply network of an aircraft,
receiving a state table from each other protection and cutoff device,
applying at least a part of the state tables to a job-related rule determining whether the contactor of the protection and cutoff device must be open or closed,
controlling the contactor according to the result of the job-related rule,
transferring an updated state table to each other protection and cutoff device.

7. The system according to claim 6, wherein the network comprises a plurality of voltage sources, a plurality of loads consuming electrical energy and a plurality of supply buses, and in that a protection and cutoff device is disposed between each voltage source and a supply bus, a protection and cutoff device is disposed between each load and a supply bus and at least one protection and cutoff device is disposed between two supply buses.

8. (canceled)

9. A non-transitory information storage medium storing a computer program comprising instructions for implementing, by a processor, the method according to claim 1, when said program is read and executed by said processor.
